(19) United States
(12) Patent Application Publication
(10) Pub. No.: US 2025/0301249 A1
(43) Pub. Date: Sep. 25, 2025

(54) Headset

(71) Applicant: Anker Innovations Technology Co., Ltd., Changsha (CN)

(72) Inventor: Yuanbao Deng, Shenzhen (CN)

(21) Appl. No.: 19/077,370

(22) Filed: Mar. 12, 2025

(30) Foreign Application Priority Data
Mar. 22, 2024 (CN) 202420573274.9

(51) Int. Cl. H04R 1/10; H04R 5/033

(52) U.S. Cl. CPC H04R 1/1008; H04R 1/1025; H04R 1/1075; H04R 5/0335

(57) ABSTRACT

A headset comprises a headband and two headset units connected to two ends of the head band respectively. Each of the two headset units comprises a headset housing, a speaker shell, an ear cap, and a battery. At least one of the two headset units further comprises a circuit board. The ear cap is connected to the headset housing in the one of the two headset units. A surface of the speaker shell in the one of the two headset units fits with an inner wall surface of the headset housing to enclose a mounting chamber. The surface of the speaker shell is formed with a first mounting surface and a second mounting surface. The first mounting surface is connected to the battery in the one of the two headset units, and the second mounting surface is connected to the circuit board.

### CROSS-REFERENCE TO RELATED APPLICATION

The present application claims priority to CN 202420573274.9, filed on Mar. 22, 2024, which is incorporated by reference by its entirety.

### TECHNICAL FIELD

The present application relates to the technical field of earphones, in particular to a headset.

### BACKGROUND

In related technologies, a battery is mounted in a single headset unit of a headset. To ensure relatively long endurance of the headset, the battery is often large-sized to obtain sufficient capacity. Therefore, the large-sized battery occupies more internal space of the headset unit and needs to be stacked inside a shell of the headset unit with other electronic components therein. Such layout makes the overall structure of the headset unit relatively thick, which is not conducive to wearing and use.

### SUMMARY

The present application describes an improved headset, which can be thinner and lighter. The present application provide a headset. A headset comprises a headband and two headset units (e.g., earcups) connected to two ends of the head band respectively. Each of the two headset units comprises a headset housing, a speaker shell, an ear cap, and a battery. At least one of the two headset units further comprises a circuit board. The ear cap is connected to the headset housing in the one of the two headset units. A surface of the speaker shell in the one of the two headset units fits with an inner wall surface of the headset housing to enclose a mounting chamber. The surface of the speaker shell is formed with a first mounting surface and a second mounting surface. The first mounting surface is connected to the battery in the one of the two headset units, and the second mounting surface is connected to the circuit board. The first mounting surface and the second mounting surface are arranged in a direction perpendicular to a thickness direction of the headset unit, and at least one of the first mounting surface and the second mounting surface is arranged at a decreasing distance from the ear cap assembly in a direction away from the other.

Based on the headset in the embodiments of the present application, the headset housing of the headset unit protects various components therein, and prevents impurities such as floating dust and water stains from entering the headset unit to damage the components. The surface of the speaker shell away from the ear cap fits with the inner wall surface of the headset housing to enclose the mounting chamber, and the mounting chamber is used for placing the devices, such as the battery and the circuit board. The ear cap is connected to the headset housing, and is used for contacting the wearer's ear and covering the outside of the user's ear, thereby reducing the pressure of the headset unit on the wearer's auricle and improving the comfort of the wearer when wearing the headset.

In the present application, the battery is provided in each of the two headset units. It can be understood that, when the headset has the same endurance as previous design, the two batteries inevitably reduce the volume and weight of each battery. Further, the surface of the speaker shell is formed with the first mounting surface and the second mounting surface, the first mounting surface and the second mounting surface are arranged in the direction perpendicular to the thickness direction of the headset unit, and at least one of the first mounting surface and the second mounting surface is arranged at the decreasing distance from the ear cap assembly in the direction away from the other, such that the back of the speaker shell is formed with a gradient mounting space in the thickness direction of the headset unit. In addition, the battery with reduced volume can be arranged side by side with the circuit board in the radial direction of the headset unit. Hence, compared to simple stacking of the battery and the circuit board in the thickness direction of the headset unit in the previous design, because the battery is offset and arranged side by side with the circuit board in the radial direction of the headset unit, the space inside the mounting chamber can be fully utilized, the thickness and overall volume of the headset unit can be reduced, the headset is thinner and lighter, bulky product design can be avoided, and the headset is thus more conducive to wearing and use.

### BRIEF DESCRIPTION OF THE DRAWINGS

To describe the technical solutions in the present application or in the prior art more clearly, the following briefly introduces the accompanying drawings required for describing the present application. Apparently, the accompanying drawings in the following description show only some examples of the present application, and those of ordinary skill in the art can derive other drawings from the accompanying drawings without any creative efforts.

FIG. 1 is a schematic diagram of headset units in an example of a headset of the present application;

FIG. 2 is an exploded view of one headset unit in the headset shown in FIG. 1;

FIG. 3 is a cross-sectional view of the headset unit shown in FIG. 2;

FIG. 4 is another cross-sectional view of the headset unit shown in FIG. 2;

FIG. 5 is an exploded view of a speaker assembly of the headset unit shown in FIG. 2; and

FIG. 6 is a schematic structural diagram of an ear cap assembly of the headset unit shown in FIG. 2.

### LIST OF REFERENCE NUMERALS

1. Headset; 10. Headset unit; 20. Headset housing; 20a. Mounting chamber; 21. Cover shell; 22. Rear headset cover; 30. Speaker assembly; 31. Speaker body; 311. Sound output surface; 32. Speaker shell; 321. Rear speaker cover; 3211. First mounting surface; 3212. Second mounting surface; 322. Limit member; 3221. Mounting groove; 323. Speaker bracket; 3231. Limit groove; 3232. Sound hole; 324. Accommodating chamber; 40. Ear cap assembly; 41. Ear cap bracket; 411. Connection surface; 42. Ear cap body; 50. Battery; 60. Circuit board.

The implementation, functional characteristics, and advantages of the present application will be further described with reference to the accompanying drawings.

### DETAILED DESCRIPTION

To make the objectives, technical solutions, and advantages of the present application clearer, the present application will be further described in detail below in conjunction with the accompanying drawings.

When the following description refers to the accompanying drawings, the same reference numerals in different drawings represent the same or similar elements, unless otherwise indicated. Implementations described in the following examples do not represent all implementations consistent with the present application. On the contrary, the implementations are merely examples of an apparatus and a method consistent with some aspects of the present application described in detail in the appended claims.

In the description of the present application, it should be understood that the terms “first”, “second”, etc. are only used for descriptive purposes and cannot be understood as indicating or implying relative importance. Those of ordinary skill in the art can understand the specific meanings of the above terms in the present application according to specific circumstances. Moreover, in the description of the present application, unless otherwise stated, “a plurality of” means two or more. The term “and/or” describes an association relationship of associated objects, indicating three relationships, for example, A and/or B may indicate that A exists alone, A and B exist at the same time, and B exists alone. The character “/” generally indicates an “or” relationship between successive associated objects.

Unless otherwise defined, all technological and scientific terms used herein have the same meanings as commonly understood by those of ordinary skill in the technical field of the present application. The terms used in the description are only for the purpose of describing specific examples, but are not intended to limit the present application. The term “and/or” used herein includes any and all combinations of one or more relevant listed items.

Currently, as a commonly used electronic product, earphones play an important role in people's lives. The earphones, classified based on their sound production mechanisms, include air conduction earphones, bone conduction earphones, etc. When distinguished by ways of wearing, the earphones include headsets, earbuds, etc. The headset has a head band (i.e., headband) and two headset units (e.g., earcups). When worn, the head band provides a certain clamping force to cover a user's ears with the two headset units. The headset has the advantages of good sound insulation during use, warmth in winter, and a cool design, and therefore, is popular among many users.

As a conventional design of the headset, a battery is mounted (e.g., placed) in one of the two headset units, and the two headset units are powered by the battery. The two headset units can be electrically connected by wiring in the head band. In order to ensure relatively long endurance, the battery is often large-sized with large capacity. Therefore, the battery occupies more internal space of the headset unit, making it difficult to arrange other components therein, such as a circuit board, which is often stacked with the battery. As a result, the headset unit is relatively thick, which is not conducive to wearing and use.

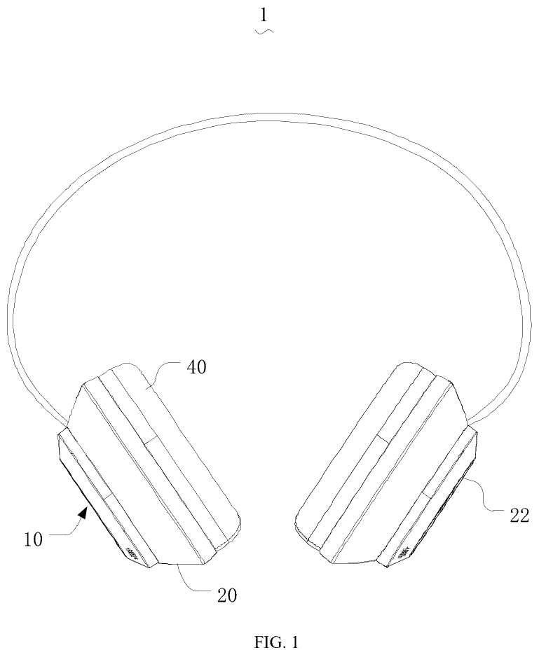

To solve the above problems, with reference to FIGS. 1 to 3, the present application provides a headset 1. In an example, the headset 1 includes a head band and two headset units 10 connected to two ends of the head band respectively. During wearing, the head band spans a user's head and provides a certain elastic clamping force to cover the user's ears with the headset units 10. For ease of description, the following content defines the side of components in the headset units 10 facing the user's ears as the front side or front, and the side away from the ear as the rear side or rear.

The head band may have a curved arc-shaped structure, which can adapt to the contour of the user's head. The head band may be designed to be stretchable and adjustable, the head band may include a skeleton and a jacket, and the jacket covers the skeleton. The material of the skeleton may be plastic or metal, and the material of the jacket may be a soft material such as leather or fabric. As such, when the jacket is in contact with a user, the user feels more comfortable. The skeleton may have a plurality of splicing units, and two splicing units may be connected in a sliding manner. By sliding and pulling the two splicing units, the length of the head band can be adjusted to adapt to users with different head circumferences, thereby improving the convenience and comfort of use. The headset units 10 are connected to the two ends of the head band respectively in a length direction. Each headset unit 10 may comprise a headset housing 20, a speaker assembly 30, an ear cap assembly 40, and a battery 50.

The headset housing 20 is connected to the head band. The ear cap assembly 40 (e.g., ear cushion) is connected to the headset housing 20, and is used for covering an outside of a user's ear. The speaker assembly 30 is located in the headset housing 20, the speaker assembly 30 is arranged in the headset housing 20, the speaker assembly 30 includes a speaker body 31 and a speaker shell 32, the speaker shell 32 is connected to the headset housing 20, and the speaker body 31 is connected to the speaker shell 32. For example, the surface of the speaker shell 32 away from the ear cap assembly 40 fits with an inner wall surface of the headset housing 20 to enclose a mounting chamber 20a.

The headset housing 20 includes a cover shell 21 and a rear headset cover 22, the rear headset cover 22 is connected to a rear side of the cover shell 21, the rear headset cover 22 is connected to the cover shell 21 by gluing or fixing with screws, and the speaker assembly 30 is arranged in the cover shell 21, such that inner wall surfaces of the cover shell 21 and the rear headset cover 22 fit with the surface of the speaker shell 32 away from the ear cap assembly 40 to enclose the mounting chamber 20a. It can be understood that the above structural form of the headset housing 20 isolates various components inside the headset unit 10 from the external environment, and achieves dust-proof and water-proof effects. Moreover, when the headset housing 20 includes the cover shell 21 and the rear headset cover 22, the headset unit 10 further has the advantage of easy disassembly and maintenance. Also or alternatively, the cover shell 21 and the rear headset cover 22 of the headset housing 20 may form a one-piece structure.

The headset housing 20 may be made of a metal material (such as aluminum). The metal material can improve the overall rigidity of the headset housing 20 and improve the impact resistance of the headset housing 20. Meanwhile, the headset housing 20 can provide better protection for components therein. It can be understood that the headset housing 20 may alternatively be made of other materials (such as plastic), where the plastic facilitates shaping and has low cost. In addition, the cover shell 21 and the rear headset cover 22 in the headset housing 20 may be made of the same material such as metal or plastic, or made of different materials, for example, the cover shell 21 is made of metal, and the rear headset cover 22 is made of plastic.

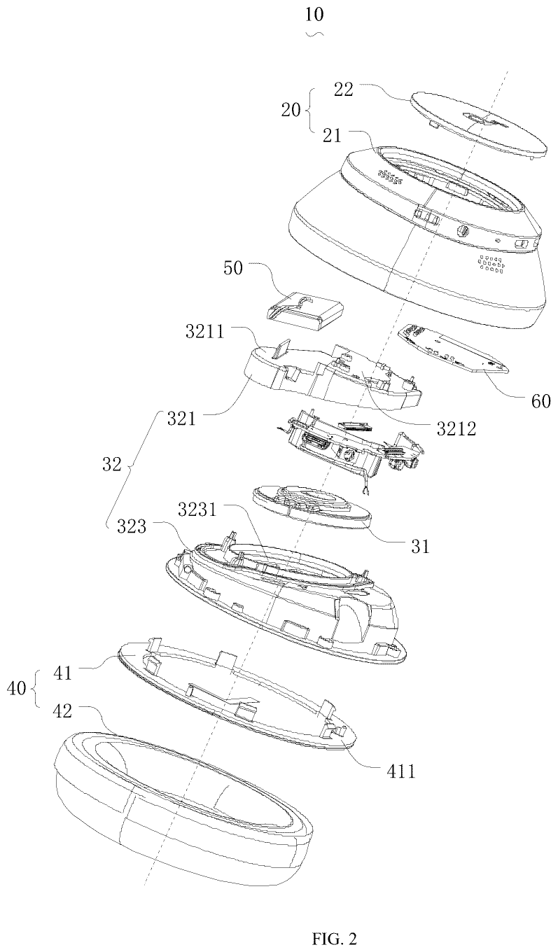

As shown in FIG. 2, the speaker assembly 30 includes the speaker body 31 and the speaker shell 32, the speaker shell 32 is connected to the headset housing 20, and the speaker body 31 is connected to the speaker shell 32. To ensure the support strength of the speaker shell 32, the speaker shell may be made of a material with relatively high strength, such as polyethylene (PE), polyvinyl chloride (PVC), polypropylene (PP), or ABS resin. The surface of the speaker shell 32 is formed with a first mounting surface 3211 and a second mounting surface 3212, the first mounting surface 3211 and the second mounting surface 3212 are arranged in a direction perpendicular to the thickness direction of the headset unit 10, and at least one of the first mounting surface 3211 and the second mounting surface 3212 is arranged at a decreasing distance from the ear cap assembly 40 in a direction away from the other.

As shown in FIG. 2, the distance between the first mounting surface 3211 and the ear cap assembly 40 decreases in the direction away from the second mounting surface 3212. The first mounting surface 3211 extends obliquely from an edge of the second mounting surface 3212 towards the ear cap assembly 40. When the headset unit 10 is regarded as an approximately circular cake, the first mounting surface 3211 and the second mounting surface 3212 are arranged in a radial direction of the entire headset unit 10. It can be understood that the first mounting surface 3211 and the second mounting surface 3212 may alternatively be spaced apart in the radial direction of the headset unit 10, or the distance between the second mounting surface 3212 and the ear cap assembly 40 decreases in the direction away from the first mounting surface 3211. When the first mounting surface 3211 extends obliquely from the edge of the second mounting surface 3212 towards the ear cap assembly 40, the headset unit 10 has a more compact structure and a smaller volume.

Further, one battery 50 is provided in each headset unit 10 in the present application. It can be understood that the capacity of the two batteries 50 may be equivalent to that of a single battery in the related art. The single battery may be replaced with the two batteries 50 to maintain original endurance (e.g., battery life). Compared to the single battery design, the design of the two batteries 50 in the present application reduces the volume of each battery 50 accordingly. In an ideal state, the volume of each battery 50 in the present application is half of that of the battery designed in the related art.

With reference to FIG. 2, at least one headset unit 10 is further provided with a circuit board 60. The circuit board 60 is electrically connected to the battery 50, the circuit board 60 is connected to the second mounting surface 3212, and the battery 50 and the circuit board 60 are jointly arranged in the mounting chamber 20a. One or two circuit boards 60 may be configured. When one circuit board 60 is configured, the circuit board 60 is a main control board. In this case, the circuit board 60 is arranged in one of the headset units 10 and electrically connected to the battery 50 in the headset unit 10, and the other headset unit 10 and the battery 50 therein are connected to the circuit board 60 through wires along the head band. The single circuit board 60 makes the overall cost of the headset units 10 lower. Alternatively, two circuit boards 60 may be configured, one of the circuit boards 60 is a main control board and the other is an adapter board. The two circuit boards 60 are arranged in the two headset units 10 respectively, the two circuit boards 60 are also electrically connected through wires in the head band, and the circuit board 60 as the main control board achieves signal control on the two headset units 10. It can be understood that such layout simplifies circuit design and can make the weights of the two headset units 10 more balanced.

In an example, the first mounting surface 3211 extends obliquely from one side of the second mounting surface 3212 towards the ear cap assembly 40, the battery 50 is connected to the first mounting surface 3211, and the circuit board 60 is mounted on the second mounting surface 3212, such that the back of the speaker shell 32 is formed with a gradient mounting space in the thickness direction of the headset unit 10. In addition, the battery 50 with small volume can be arranged side by side with the circuit board 60 in the radial direction of the headset unit 10. Hence, compared to simple stacking of the battery and the circuit board in the thickness direction of the headset unit in the related art, because the battery 50 is offset and arranged side by side with the circuit board 60 in the radial direction of the headset unit 10, the space inside the mounting chamber 20a can be fully utilized, the headset unit 10 has a relatively small size in the thickness direction, the thickness and overall volume of the headset housing 20 can be reduced, the headset 1 is thinner and lighter, bulky product design can be avoided, and the headset is thus more conducive to wearing and use.

After the battery 50 and the circuit board 60 are assembled, the circuit board 60 is at least partially located on the rear side of the battery 50 away from the ear cap assembly 40. As such, in the mounting process of the circuit board 60, the rear space of the battery 50 can be fully utilized, and the circuit board 60 can block the battery 50 in a direction of movement towards the rear side, to prevent the battery 50 from detaching towards the rear side. Understandably, the first mounting surface 3211 is arranged obliquely relative to the second mounting surface 3212, the circuit board 60 and the battery 50 are located on two different mounting surfaces, and the overlap, if any, between the circuit board 60 and the battery 50 in a front-rear direction of the headset unit 10, is different from the stacking of the two on the same plane in the previous design, so the thickness of the headset unit 10 may not increase.

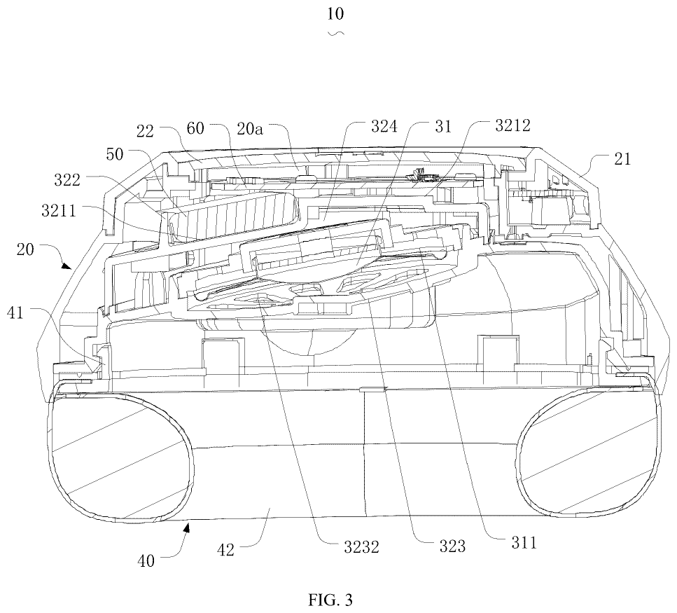

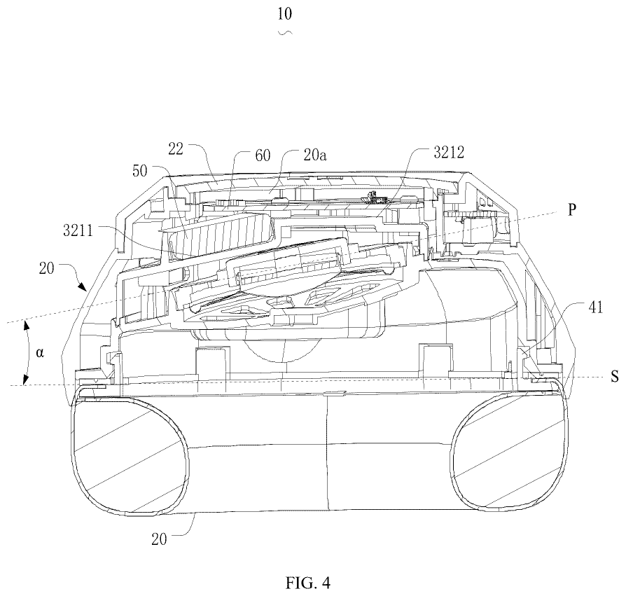

For easy assembly of the battery 50, a limit member 322 (see FIG. 3 and FIG. 4) is further connected to the back of the speaker shell 32, the limit member 322 is arranged at the edge of the first mounting surface 3211 and encloses with the first mounting surface 3211 to form a mounting groove 3221. The battery 50 is embedded in the mounting groove 3221, and the battery 50 is stably fixed on the first mounting surface 3211. The limit member 322 may have a lug structure. The limit member 322 may be a protruding piece of metal or plastic, or a raised edge, plate, or bracket. A plurality of limit members 322 may be configured to surround an outer circumference of the battery 50. In order to stably clamp the battery 50, the limit member 322 is in interference fit with the battery 50. The battery 50 may be alternatively fixed to the first mounting surface 3211 by fasteners or screws. The present application does not limit the form of fixing the battery 50. To further ensure the reliable connection of the battery 50 on the first mounting surface 3211 and prevent the battery 50 from loosening, an adhesive layer may be further provided between the battery 50 and the first mounting surface 3211. The material of the adhesive layer may be a double-sided tape, resin, etc.

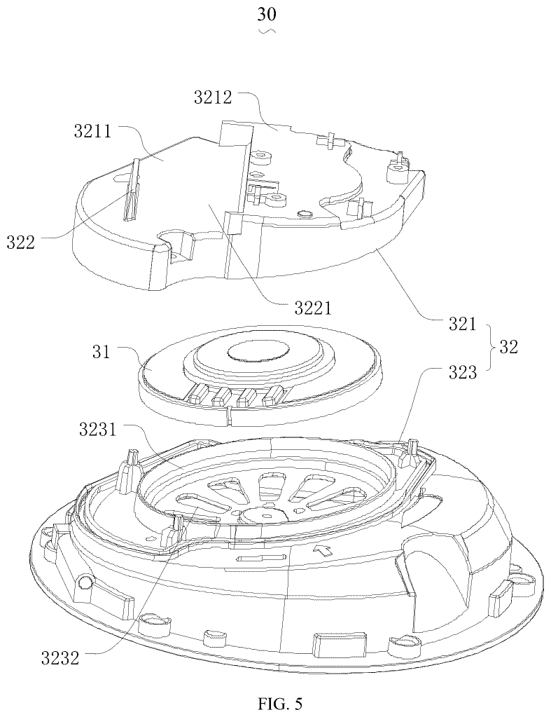

Specifically, with reference to FIG. 3 to FIG. 5, the speaker shell 32 includes a rear speaker cover 321 and a speaker bracket 323 that are detachably connected. The speaker bracket 323 is connected to the headset housing 20. The rear speaker cover 321 covers the side of the speaker bracket 323 away from the ear cap assembly 40. The rear speaker cover 321 has the first mounting surface 3211 and the second mounting surface 3212 mentioned above. The rear speaker cover encloses with the speaker bracket 323 to form an accommodating chamber 324 (see FIG. 3), and the speaker body 31 is arranged in the accommodating chamber 324. The speaker bracket 323 encloses the accommodating chamber 324 to isolate the speaker body 31 from other components in the headset unit 10, thereby achieving good protection for the speaker body 31. For easy positioning and assembly of the speaker body 31, the portion of the speaker bracket 323 in the accommodating chamber 324 is formed with a limit groove 3231 (see FIG. 5), and the speaker body 31 is embedded in the limit groove 3231. Such arrangement avoids shift, loosening, etc. of the speaker body 31 due to its vibration during audio transmission, and ensures smooth and stable sound output.

To further ensure the stability of mounting of the speaker body 31 on the speaker bracket 323, a screw connection structure, a clamping connection structure, etc. may be provided between the speaker body 31 and the speaker bracket 323, which is not limited by the present application. Moreover, for the specific form of the speaker shell 32, the rear speaker cover 321 and the speaker bracket 323, as two split portions illustrated in the figures, may alternatively have a one-piece structure. As such, the speaker body 31 and the speaker bracket 323 may be fixed by screw connection, clamping, etc.

As shown in FIG. 3 to FIG. 5, in an example, the speaker body 31 includes a sound output surface 311 facing the ear cap assembly 40. The speaker body 31, as a sound production unit, includes an auxiliary system, a vibration system, and a magnetic circuit system. The auxiliary system mainly has a shell structure, the vibration system includes a diaphragm, a voice coil, etc., and the magnetic circuit system includes a magnetic yoke, a spring washer, etc. A front cover of the auxiliary system is pressed on an edge of the diaphragm of the vibration system. Here, the sound output surface 311 may be the surface of the front cover facing the ear cap assembly 40 (e.g., the sound output surface 311 is a plane P as shown in FIG. 4). The first mounting surface 3211 is parallel to the sound output surface 311, which can avoid interference between the mounting of the speaker body 31 and the arrangement of the speaker shell 32 when the first mounting surface 3211 of the speaker shell 32 extends towards the ear cap assembly 40 (e.g., the speaker body 31 is mounted obliquely to adapt to the layout of the battery 50).

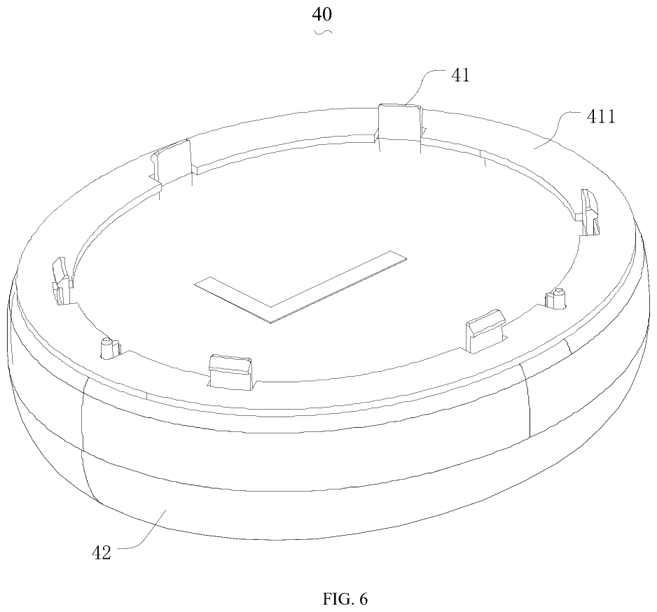

With reference to FIG. 6, the ear cap assembly 40 includes an ear cap bracket 41 and an ear cap body 42, where the ear cap bracket 41 is connected to the speaker shell 32. Specifically, the speaker bracket 323 is connected to the ear cap bracket 41 by clamping, screwing, etc. The ear cap bracket 41 is annular and its main body has a plate-shaped structure. The ear cap bracket 41 has a connection surface 411 facing the speaker shell 32 (e.g., the connection surface 411 is a plane S as shown in FIG. 4). The connection surface 411 is arranged parallel to the second mounting surface 3212, that is, the circuit board 60 mounted on the second mounting surface 3212 is arranged parallel to the connection surface 411, which can reduce the relative distance between the circuit board 60 and the connection surface 411 in the front-rear direction of the headset unit 10, thereby reducing the thickness of the headset housing 20 in the front-rear direction of the headset unit 10.

The ear cap body 42 is arranged on the side of the ear cap bracket 41 away from the connection surface 411 and connected to the ear cap bracket 41. The connection may be fixed connection, such as bonding, to prevent the ear cap body 42 from falling off. Alternatively, the connection may be detachable connection, such as sleeve connection or clamping, which enables users to replace the ear cap assembly 40 according to maintenance needs or sound quality needs, and meets the use needs of different users, with a wide range of applications and good universality. The ear cap body 42 is annular and surrounds the edge of the ear cap bracket 41, and the ear cap assembly 40 is made of a soft material such as memory sponge. When the user wears the headset 1 of the present application, the ear cap body 42 can make full and close contact with the wearer's auricle, thereby achieving high noise resistance.

In one example, the connection surface 411 and the sound output surface 311 are arranged at an angle, that is, the plane S and the plane P are arranged at an angle a as shown in FIG. 4. As such, when the user wears the headset 1 of the present application, audio information transmitted by the headset 1 is maintained in contact with the wearer's auricle through the ear cap assembly 40 and output to the user's ear. At this time, the speaker shell 32 adaptively fits with the wearer's auricle to form a certain angle, without pressing the wearer's auricle, thereby reducing discomfort caused by pressing the auricle during wearing, improving wearer's comfort, and ensuring stable transmission of sound. The angle a between the connection surface 411 and the sound output surface 311 should not be excessively small to ensure that the speaker shell 32 does not squeeze the wearer's auricle. The angle a should also not be excessively large to avoid increasing the mounting volume of the speaker assembly 30 inside the headset housing 20, to increase the volume of the entire headset unit 10. In addition, if the angle between the speaker body 31 and the user's auricle is too large, audio may leak, which affects the sound output effect. Therefore, for example, the angle a may be greater than or equal to 5 degrees and less than or equal to 15 degrees, (e.g., the angle a may be any value greater than or equal to 5 degrees and less than or equal to 15 degrees, such as 5 degrees, 6degrees, 7 degrees . . . 13 degrees, 14 degrees, or 15 degrees).

To match the shape of the speaker body 31, the top view of the speaker bracket 323 is circular, and the speaker body 31 is embedded in the limit groove 3231 of the speaker bracket 323. To adapt to the angle a between the connection surface 411 of the ear cap bracket 41 and the sound output surface 311 of the speaker body 31, as shown in FIG. 5, the front view of the speaker bracket 323 is hat-shaped, and the side of the speaker bracket 323 adjacent to the speaker body 31 is also at the same angle a with the sound output surface 311. The speaker bracket 323 is further formed with a sound hole 3232, the sound hole 3232 is in communication with the accommodating chamber 324 and is opposite to the sound output surface 311 of the speaker body, and the audio produced by the speaker body 31 can be transmitted to the outside of the headset unit 10 via the sound hole 3232.

The same or similar reference numerals in the accompanying drawings correspond to the same or similar components. In the description of the present application, it should be understood that, if the terms such as “up”, “down”, “left”, and “right” indicate orientations or positional relationships based on the orientations or positional relationships shown in the accompanying drawings, the terms are only for the convenience of describing the present application and simplifying the description, and do not indicate or imply that an apparatus or component referred to must have a specific orientation or be constructed and operated in a specific orientation. Therefore, the terms for describing the positional relationships in the accompanying drawings are only for illustrative description and cannot be understood as limitations of this patent. Those of ordinary skill in the art can understand the specific meanings of the above terms according to specific situations.

Described above are merely some of the examples of the present application, which are not used for limiting the present application. Any modification, equivalent replacement and improvement, and the like made within the spirit and principle of the present application shall fall within the protection scope of the present application.

What is claimed is:

1. A headset comprising:
a headband; and
two headset units connected to two ends of the headband respectively, each of the two headset units comprising a headset housing, a speaker shell, an ear cap, and a battery, wherein:
one of the two headset units further comprises a circuit board,
the ear cap is connected to the headset housing in the one of the two headset units,
a surface of the speaker shell in the one of the two headset units fits with an inner wall surface of the headset housing to enclose a mounting chamber,
the surface of the speaker shell is formed with a first mounting surface and a second mounting surface,
the first mounting surface is connected to the battery in the one of the two headset units, and
the second mounting surface is connected to the circuit board.

2. The headset according to claim 1, wherein:
the first mounting surface and the second mounting surface are arranged in a direction perpendicular to a thickness direction of the one of the two headset units, and at least one of the first mounting surface and the second mounting surface is arranged at a decreasing distance from the ear cap in a direction away from the other one of the first mounting surface and the second mounting surface.

3. The headset according to claim 1, further comprising a lug, wherein the lug fits with the first mounting surface to enclose a mounting groove, and
the battery is embedded in the mounting groove.

4. The headset according to claim 1, further comprising an adhesive layer between the battery and the first mounting surface.

5. The headset according to claim 1, wherein the circuit board is at least partially located on a side of the battery away from the ear cap.

6. The headset according to claim 1, further comprising a speaker, wherein the speaker comprises a sound output surface facing the ear cap,
wherein a distance between the first mounting surface and the ear cap decreases in a direction away from the second mounting surface, and
wherein the first mounting surface is parallel to the sound output surface.

7. The headset according to claim 6, wherein:
the ear cap comprises an ear cap bracket connected to the speaker shell,
the ear cap bracket has a connection surface facing the speaker shell, and
the connection surface is arranged at an angle with the sound output surface.

8. The headset according to claim 7, wherein an angle between the connection surface and the sound output surface is greater than or equal to 5 degrees and less than or equal to 15 degrees.

9. The headset according to claim 1, wherein:
the speaker shell comprises a rear speaker cover and a speaker bracket that are detachably connected,
the speaker bracket is connected to the headset housing,
the rear speaker cover covers a side of the speaker bracket away from the ear cap,
the rear speaker cover and the speaker bracket form an accommodating chamber,
a speaker is arranged in the accommodating chamber, and
the rear speaker cover has the first mounting surface and the second mounting surface.

10. The headset according to claim 9, wherein a portion of the speaker bracket in the accommodating chamber is formed with a limit groove, and the speaker is embedded in the limit groove.

11. The headset according to claim 7, wherein the connection surface is arranged parallel to the second mounting surface.

12. The headset according to claim 1, wherein the battery and the circuit board are in the mounting chamber.

13. A headset comprising:
a headband; and
two headset housings connected to the headband, each of the two headset housings comprising a speaker shell and a battery, wherein:
one of the two headset housings comprises a circuit board,
a surface of the speaker shell fits with an inner wall surface of the one of two headset housings to enclose a mounting chamber that covers the battery and the circuit board,
the surface of the speaker shell is formed with a first mounting surface and a second mounting surface,
the first mounting surface is connected to the battery, and
the second mounting surface is connected to the circuit board.

14. The headset according to claim 13, further comprising a lug, wherein the lug fits with the first mounting surface to enclose a mounting groove, and
the battery is embedded in the mounting groove.

15. The headset according to claim 13, further comprising an adhesive layer between the battery and the first mounting surface.

16. The headset according to claim 13, further comprising an ear cap and a speaker, wherein the speaker comprises a sound output surface facing the ear cap,
wherein a distance between the first mounting surface and the ear cap decreases in a direction away from the second mounting surface, and
wherein the first mounting surface is parallel to the sound output surface.

17. The headset according to claim 13, wherein:
the speaker shell comprises a rear speaker cover and a speaker bracket that are detachably connected,
the rear speaker cover covers a side of the speaker bracket,
the rear speaker cover and the speaker bracket form an accommodating chamber,
a speaker is arranged in the accommodating chamber, and
the rear speaker cover has the first mounting surface and the second mounting surface.

18. The headset according to claim 17, further comprising a speaker, wherein a portion of the speaker bracket in the accommodating chamber is formed with a limit groove, and the speaker is embedded in the limit groove.

19. The headset according to claim 13, wherein the circuit board is connected to the battery in the one of the two headset housings and a second battery in another one of the two headset housings.

20. A headset comprising:
a headband; and
two headset housings connected to the headband, each of the two headset housings comprising a speaker shell and a battery, wherein:
one of the two headset housings comprises a circuit board,
a surface of the speaker shell fits with an inner wall surface of the one of two headset housings to enclose a mounting chamber that covers the battery and the circuit board, and
the surface of the speaker shell is connected to the battery and the circuit board.
